(19) United States
(12) Patent Application Publication
(10) Pub. No.: US 2024/0368888 A1
(43) Pub. Date: Nov. 7, 2024

(54) Structural Member and Method of Producing a Structural Member

(71) Applicant: Austrak Pty Ltd, Brisbane (AU)

(72) Inventors: Simon LAMBERT, Brisbane (AU); Daniel BAXTER, Brisbane (AU); Medhi KHAMMER, Rowville (AU)

(21) Appl. No.: 18/654,941

(22) Filed: May 3, 2024

(30) Foreign Application Priority Data
May 4, 2023 (AU) 2023901328

(51) Int. Cl. E04C 3/29

(52) U.S. Cl. CPC E04C 3/29

(57) ABSTRACT

A composite load-bearing member is disclosed. The member includes a core with opposed upper and lower side and opposed lateral sides extending between the upper and lower side and opposed ends extending between the upper and lower sides and between the lateral sides and with a longitudinal axis extending through the ends. The core is substantially solid. The member further includes a shell that is bonded to the core on at least the upper, lower and lateral sides and that includes first reinforcing fibres and second reinforcing fibres in a first resin matrix. The first reinforcing fibres are parallel to the longitudinal axis and the second reinforcing fibres are oblique to the longitudinal axis. Also disclosed is a method of forming the composite load-bearing member.

### CROSS REFERENCE TO RELATED APPLICATIONS

This application claims priority from Australian application 2023901328, filed on 4 May 2023. The disclosure of the Australian application is incorporated herein by this reference in its entirety.

### TECHNICAL FIELD

This application relates to structural members, such as beams, transoms and decking.

More specifically, it relates to structural members formed of composite materials.

### BACKGROUND

The term “composite materials” used herein is a reference to materials comprising reinforcing fibres embedded in a host matrix.

Composite materials are used in applications where excellent mechanical properties are required. In some applications, the composite material forms a hollow structure, such as a tube, to take advantage of the strength and relatively light weight of the composite material. In other applications, a lightweight foamed panel is sandwiched between a pair of composite material plates.

While tubes and sandwich structures including composite materials are suitable for a large range of applications, some structural applications require additional properties that aren't present in tubes and sandwich structures.

It is desirable, therefore, to provide alternative structural members formed of composite materials.

The above references to the background art do not constitute an admission that the art forms a part of the common general knowledge of a person of ordinary skill in the art. The above references are also not intended to limit the application of the apparatus and method as disclosed herein.

### SUMMARY OF THE DISCLOSURE

There is provided in one aspect a composite load-bearing member including:
a core with opposed upper and lower sides and opposed lateral sides extending between the upper and lower sides and opposed ends extending between the upper and lower sides and between the lateral sides and with a longitudinal axis extending through the ends, the core being substantially solid; and
a shell that is bonded to the core on at least the upper, lower and lateral sides and that includes first reinforcing fibres and second reinforcing fibres in a first resin matrix; and

wherein the first reinforcing fibres are parallel to the longitudinal axis and the second reinforcing fibres are oblique to the longitudinal axis.

The first reinforcing fibres may wrap continuously from one of the ends and across the upper side or the lower side to the other end.

The first reinforcing fibres may extend at least partly across each end.

At least some of the second reinforcing fibres wrap continuously and helically from the upper or lower sides and across the lateral side to the lower or upper side, respectively.

The second reinforcing fibres may include a first group that is oriented at a first oblique angle (A) to the longitudinal axis and a second group that is oriented at a second oblique angle (B) to the longitudinal axis.

The second reinforcing fibres may include a first group that is oriented at one or more first oblique angles (A) to the longitudinal axis and a second group that is oriented at one or more second oblique angles (B) to the longitudinal axis.

The angles A and B may be symmetrical about the longitudinal axis.

The angles A and B may be non-symmetrical about the longitudinal axis.

The angle A may be in the range of +>0° to <90° to the longitudinal axis and the angle B is in the range of −>0° to <90° to the longitudinal axis.

The second reinforcing fibres may include a third group that is oriented at 90° to the longitudinal axis.

The fibre density of the first reinforcing fibres may be in the range of 100 to 30,000 g/m².

The fibre density of the first reinforcing fibres may be in the range of 1,000 to 10,000 g/m².

The fibre density of the second reinforcing fibres may be in the range of 100 to 30,000 g/m².

The fibre density of the second reinforcing fibres may be in the range of 1000 to 8,000 g/m².

The core may include a plurality of sub-core units and adjacent sub-core units that are bonded to a shear reinforcement panel.

The or each shear reinforcement panel may be aligned in a direction generally orthogonal to the upper and lower sides of the core.

The or each shear reinforcement panel may be aligned generally parallel to the longitudinal axis of the core.

The or each shear reinforcement panel may be aligned in a direction generally parallel to the upper and lower sides of the core.

The or each shear reinforcement panel may be aligned obliquely to the longitudinal axis of the core.

The or each shear reinforcement panel may be aligned obliquely to the lateral sides of the core and is aligned generally parallel to the longitudinal axis of the core.

The or each shear reinforcement panel may extend between the upper and lower sides of the core.

The or each shear reinforcement panel may include third reinforcing fibres in a resin matrix.

The fibre density of the third reinforcing fibres may be in the range of 100 to 10,000 g/m².

The fibre density of the third reinforcing fibres may be in the range of 300 to 3,000 g/m².

The fibre density of the third reinforcing fibres may be in the range of 400 to 2,500 g/m².

The or each shear reinforcement panel may be planar and includes the third reinforcing fibres which include a first group of generally parallel fibres and a second group of parallel fibres, the first group and the second group are generally parallel to the plane of the shear reinforcement panel and are perpendicular to each other.

The third reinforcing fibres may include a third group of generally parallel fibres that are generally parallel to the plane of the shear reinforcement panel and are oriented at 45° to the first and second groups of the third reinforcing fibres.

The plane of the or each shear reinforcement panel may be generally parallel to the longitudinal axis and the third group of third reinforcing fibres is orthogonal to the longitudinal axis.

The resin matrix may be part of the first resin matrix or may be a second resin matrix that is separate from the first resin matrix.

At least a part of the third reinforcing fibres may extend across the upper or lower sides or across the upper and the lower sides.

At least part of the third reinforcing fibres may extend across the upper or lower side of one of the sub-core units and across the lower or upper side, respectively, of an adjacent one of the sub-core units.

At least part of the third reinforcing fibres may be incorporated into the shell.

The core may include a shear reinforcement frame comprising third fibres in the second resin matrix or a third resin matrix.

The shear reinforcement frame may include a plurality of joined frame members.

At least some of the joined frame members may intersect.

The shear reinforcement frame may have a honeycomb structure.

Some of the frame members may extend between the upper and lower sides.

Some of the frame members may extend between the lateral sides.

Some of the frame members may be generally parallel to the longitudinal axis.

Some of the frame members may be oblique to the longitudinal axis.

The core may include an organic material.

The core may be wood or may include wood chips or wood fibres.

The core may be a composite of the organic material in a synthetic material matrix.

The core may be a composite of particulate filler or fibre reinforcement in a synthetic material matrix.

The core may be foamed synthetic material.

The sub-core units may be one of the materials defined in the above statements.

The sub-core units may be different materials selected from any one of the materials defined in the above statements.

The composite load-bearing member may be a transom for railway applications.

In another aspect, there is provided a method of producing a composite load-bearing member comprising a core with opposed upper and lower sides and opposed lateral sides extending between the upper and lower sides and opposed ends extending between the upper and lower sides and between the lateral sides and with a longitudinal axis extending through the ends, the core being substantially solid; and including a shell that is bonded to at least the upper, lower and lateral sides of the core and that includes first reinforcing fibres and second reinforcing fibres in a first resin matrix, the first reinforcing fibres are parallel to the longitudinal axis and at least some of the second reinforcing fibres wrap continuously and helically from the upper or lower sides and across one of the lateral sides to the lower or upper side, respectively;

the method including:
providing the core;
wrapping the first reinforcing fibres and the second reinforcing fibres around the core so that the first reinforcing fibres are parallel to the longitudinal axis;
forming and bonding the shell to the core by applying the first resin to the first reinforcing fibres and the second reinforcing fibres and allowing the resin to cure.

The method may include providing the first and the second reinforcing fibres as a fabric that has a width that is less than, equal to or greater than the distance between the ends of the core and whereby wrapping the first reinforcing fibres and the second reinforcing fibres around the core involves wrapping the fabric around the core.

The first resin may be applied before wrapping the fabric around the core.

The first resin may be applied after wrapping the fabric around the core.

The first resin may be applied by resin infusion or by resin transfer.

The first resin may be applied during wrapping the fabric around the core.

Wrapping the fabric around the core may include connecting a leading edge of the fabric to the core and then rotating the core about the longitudinal axis to wrap the fabric circumferentially around the core.

Wrapping the fabric around the core may include connecting a leading edge of the fabric to the core and then wrapping the fabric circumferentially around the core while the core is stationary.

Wrapping the first reinforcing fibres and the second reinforcing fibres around the core may include wrapping at least some of the second reinforcing fibres continuously and helically from the upper or lower sides and across at least one of the lateral sides to the lower or upper side, respectively.

The core may include a plurality of sub-core units and the method includes arranging third reinforcing fibres between the sub-core units prior to wrapping the first and second reinforcing fibres around the core.

Arranging the third reinforcing fibres may include arranging a web of the third reinforcing fibres between adjacent sub-core units and alternately across upper sides and lower sides of adjacent sub-core units.

Connecting the leading edge of the fabric to the core may include fixing the leading edge to the core with an adhesive or with mechanical fasteners.

Connecting the leading edge of the fabric to the core may include fixing the leading edge between adjacent sub-core units by clamping the leading edge between the sub-core units or by adhering the leading edge to one of the sub-core units in a space between adjacent sub-core units or by fastening the leading edge with mechanical fasteners to one of the sub-core units in a space between adjacent sub-core units.

### BRIEF DESCRIPTION OF THE DRAWINGS

Notwithstanding any other forms which may fall within the scope of the apparatus and method as set forth in the Summary, specific embodiments will now be described, by way of example only, with reference to the accompanying drawings in which:

FIG. 1 is an isometric oblique view of a transom in accordance with the first aspect and which schematically shows first reinforcing fibres parallel with the longitudinal axis of the transom and two groups of second reinforcing fibres oriented at angles either side of the longitudinal axis.

FIG. 2 is a top plan view of part of the upper side of the transom in FIG. 1 showing the orientations of the first reinforcing fibres and showing the orientation of the first, second and third groups of second reinforcing fibres.

FIG. 3 is a schematic cross-section through the transom of FIG. 1 showing a core and shell structure where the core has six sub-core units and five reinforcement panels according to one embodiment.

FIG. 4 is a schematic representation of wrapping fibre fabric around the core in accordance with the second aspect.

FIG. 5 is a schematic cross-section of core and shell structure showing helical wrapping of fibre fabric around a core according to the second aspect.

FIG. 6 is an alternative embodiment of a core and shell structure with the core comprising three sub-core units and two reinforcement panels.

FIG. 7 is a schematic representation of the transom of FIG. 1 with an alternative configuration of reinforcement panels.

FIG. 8 is a schematic representation of the transom of FIG. 1 with a further alternative configuration of reinforcement panels.

FIG. 9 is a schematic representation of the transom of FIG. 1 with another alternative configuration of reinforcement panels.

FIG. 10 is a schematic representation of a shear reinforcement panel shown in FIG. 3, along with a representation of the orientation of third reinforcing fibres.

### DETAILED DESCRIPTION

An embodiment of a composite structural member will now be described in the following text which includes reference numerals that correspond to features illustrated in the accompanying Figures. To maintain clarity of the Figures, however, all reference numerals are not included in each Figure.

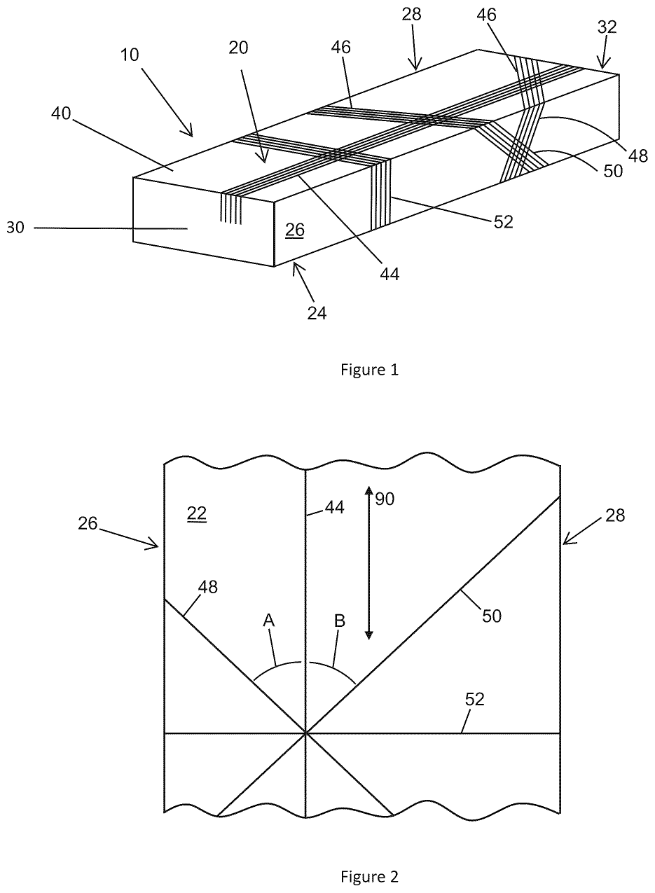

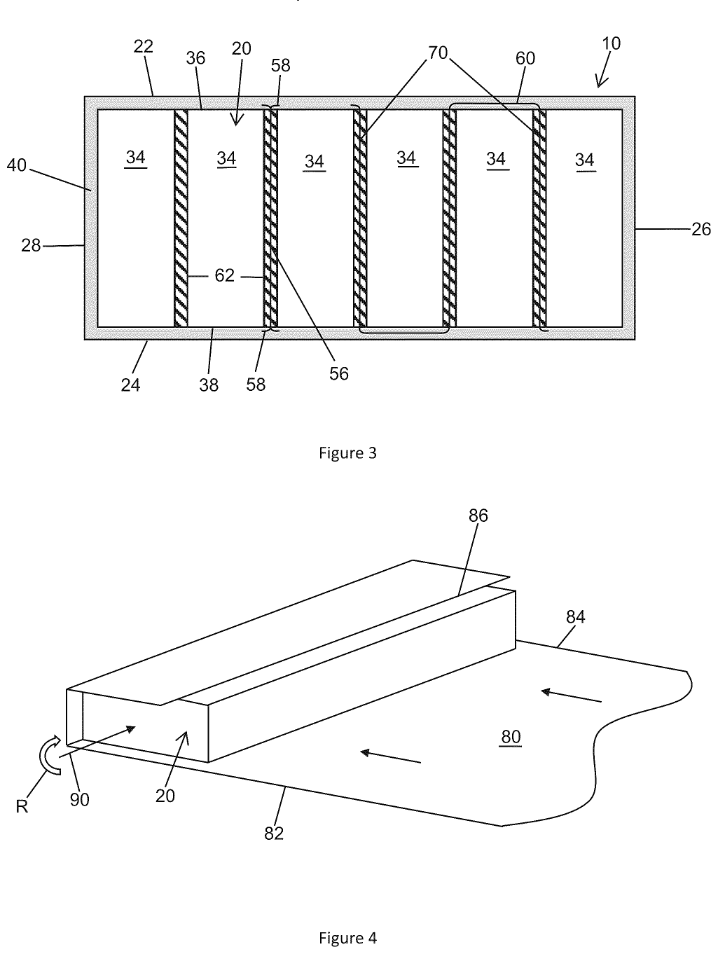

The composite structural member described below and shown in FIGS. 1 and 3 is a transom 10 which is used for supporting railway lines on bridge beams. The transom 10 is designed to contact the bridge beams on a lower side 24 at locations adjacent to the ends of the transom 10. The railway lines are located on an upper side 22 of the transom and slightly inboard of the contact points of the bridge beams. Accordingly, the transom 10 is subject to 4-point loading and the structure of the transom 10 is configured to optimise performance based on that 4-point loading. It will be appreciated, however, that alternative configurations may be adopted for where the loading arrangements are different and for alternative applications. One such alternative configuration involves the railway lines being aligned directly over the bridge beams, so that the transom 10 would primarily be in compression loading. Other alternative configurations include alternative forms of the composite structural member, such as beams and panels.

As mentioned above, the transom 10 is configured for supporting railway lines on bridge beams, but the same configuration can be used to support railway lines when the transom 10 is supported on railway ballast. The transom 10 includes the upper side 22, the lower side 24 and opposed first and second lateral sides 26, 28 which extend between the upper side 22 and the lower side 24. The transom 10 further includes first and second ends 30, 32 adjacent to the upper side 22, the lower side 24 and the first and second lateral sides 26, 28. The transom 10 shown in FIGS. 1 and 3 is a rectangular prism. The transom 10 has a longitudinal axis 90. Given the form of the rectangular prism, the transom 10 has a 2-fold rotational axis of symmetry about the longitudinal axis 90. However, the transom 10 may take the form of an alternative polygonal prismatic shape. For example, the transom 10 may have draft angles on the first and second lateral sides 26, 28. In which case the profile has the form of a parallelogram.

As shown in FIG. 3, the transom 10 comprises a core 20 and shell 40. The core 20 may be a monolithic structure. The core 20 may be a load-bearing component of the transom 10. The selection of materials from which the core 20 is formed may vary depending on the particular application of the composite structural member. For example, for the transom, the core 20 may be any suitable synthetic or organic structural material, including wood, foamed plastics and fibre reinforced plastics. Alternatively, the core 20 may be a combination of organic and synthetic materials. For example, the core may comprise wood chips in a synthetic adhesive or resin matrix. The selection of the material to form the core is based on the properties required for the composite structural member as a whole. Accordingly, the selected material may have additional properties beyond the structural properties necessitated by the load-bearing requirements. An example for this particular application, i.e. as a transom 10 in a railway, is that the core must be capable of receiving and securing fasteners that fix railway lines in place on top of the transom 10. It will be appreciated that a core 20 comprising foamed plastics may not be suitable in this particular application given the need for shear strength, tensile strength and for receiving and securing fasteners.

The core 20 shown in FIG. 3 comprises sub-core units 34 interleaved with reinforcement panels 70. Each sub-core unit 34 has top and underneath sides 36, 38 and lateral sides 62 (FIG. 3). The spacing between the lateral sides 62 of each sub-core unit 34 is less than the spacing between the top and underneath sides 36, 38. Although the transom 10 is shown to have six sub-core units 34, the core 20 may have fewer or more sub-core units 34 depending upon the performance and size requirements of the transom 10. The same factors of performance and size have a role in determining the profile of the sub-core units 34. In other words, the profile of sub-core units 34 may differ from the profile shown in FIG. 3 and the configuration of the sub-core units 34 may differ as well. For example, the core may comprise three sub-core units 34, one disposed at each lateral side of the core 20, and one central sub-core unit 34 which is approximately four times the width of the sub-core units 34 disposed of the lateral sides of the core 20. It will be appreciated, therefore there is considerable variation in the configuration of the core 20 in terms of whether it is a monolithic block or whether it comprises sub-core units 34 and in terms of the shape, size and configuration of the sub-core units 34.

The shell 40 comprises fibre reinforced plastics. As shown in FIGS. 1 and 2, the shell comprises first reinforcing fibres 44 parallel to the longitudinal axis 90 of the core and second reinforcing fibres 46 are oblique to the longitudinal axis 90 of the core 20. The first reinforcing fibres 44 extend at least partly across each end 30, 32 of the core 20. The second reinforcing fibres 46 includes first, second and third groups 48, 50 and 52 as shown in FIG. 1. In other embodiments, the second reinforcing fibres 46 may include only the first and second groups 48 and 50.

The first, second and third groups 48, 50 and 52 are shown schematically in FIG. 1 as small groups of parallel fibres. However, the first, second and third groups 48, 50 and 52 are groups of parallel fibres that cover the entirely of the upper, lower and both lateral sides, 22, 24, 26, 28 of the core 20. A small number of fibres in each group is shown in FIG. 1 for clarity regarding the orientation of the fibres. Each of the first, second and third groups 48, 50 and 52 comprises generally parallel reinforcing fibres. The first group 48 is oriented at a first oblique angle A relative to the longitudinal axis 90. The second group 50 is oriented at a second oblique angle B relative to the longitudinal axis 90. In the embodiment shown in FIG. 2, the angles A and B are the same on either side of the longitudinal axis 90. In other words, the first group 48 and the second group 50 are oriented symmetrically either side of the longitudinal axis 90. In other embodiments, the angles A and B may be different. In each of these embodiments, the angles A and B may be in the range of >0 and <90 relative to the longitudinal axis 90. In the embodiment shown in FIG. 2, the angles A and B are −45° and +45°, respectively. The third group of fibres is oriented at 90° to the longitudinal axis 90.

In this embodiment, the oblique orientation of the first group 48 and the second group 50 means that at least some of the fibres in those groups wrapped continuously and helically from the upper side 22, across 1 of the first or second lateral sides 26, 28 to the lower side 24. This wrapping can be seen in FIG. 1 regarding the first group 48 and the second group 50. The term “wrapping” refers to the continuous passage of fibres from one side to another side around an edge of the core 20 where the one side and the other side meet. This “wrapping” is enabled by having long fibres as part of the shell 40.

The fibre density of the first reinforcing fibres 44 is in the range of 100 to 30,000 g/m². Optionally, the fibre density of the first reinforcing fibres 44 is in the range of 1000 to 10,000 g/m². The fibre density of the second reinforcing fibres 46 is in the range of 100 to 30,000 g/m². Optionally, the fibre density of the second reinforcing fibres 44 is in the range of 1000 to 8,000 g/m².

The first reinforcing fibres 44 are distributed uniformly about the core 20. This results in a fibre density of the first reinforcing fibres 44 being the same on the upper side 22, the lower side 24 and on each of the first and second lateral sides 26, 28. However, the distribution of the first reinforcing fibres 44 may be non-uniform. For example, the first reinforcing fibres 44 may have a higher density distribution on the upper and lower sides 22, 24 than on the first and second lateral sides 26, 28. Alternatively, the reinforcing fibres 44 may have a higher density distribution on the first and second lateral sides 26, 28 than the distribution of first reinforcing fibres 44 on the upper and lower sides 22, 24. In a further alternative, the distribution of first reinforcing fibres 44 may be nonuniform across one or more of the upper side 22, lower side 24, first lateral side 26 and the second lateral side 28. Such non-uniform distribution may comprise regions having a higher density of first reinforcing fibres 44. For example, the density of first reinforcing fibres may be higher in a central region of the upper and lower sides 22, 24 than the density of first reinforcing fibres 44 in regions either side of the central region. The regions either side of the central region may be adjacent to an edge of the first or second lateral sides 26, 28.

The distribution of the first reinforcing fibres 44 in the shell 40 is determined by the performance requirements of the transom 10. Generally speaking, the distribution of the first reinforcing fibres 44 is selected to be higher in regions which are subject to higher loading. The embodiment of a transom 10 supporting railway lines on bridge beams, the density of the first reinforcing fibres 44 may be higher on the upper and lower sides, 22, 24 because longitudinal fibres running along the first and second lateral sides 26, 28 between the ends 30, 32 contribute less to bending resistance than longitudinal fibres running along the upper and lower sides 22, 24 between the ends 30, 32.

The first reinforcing fibres 44 are distributed uniformly about the core 20. This results in a fibre density of the first reinforcing fibres 44 being the same on the upper side 22, the lower side 24 and on each of the first and second lateral sides 26, 28. In alternative embodiments, however, the fibre density of the first reinforcing fibres may be greater on the upper side 22 and/or the lower side 24 than on each of the first and second lateral sides 26, 28.

The fibre density of the first, second and third groups 48, 50, 52 that make up the second reinforcing fibres 46 may differ from one another. For example, the fibre density of the third group 52 may be less than the fibre density of the first and second groups 48, 50. Alternatively, the fibre density of the third group 52 may be more than the fibre density of the first and second groups 48, 50. In a further alternative, the fibre density of the first group 48 may be more than the fibre density of the second group 50. Alternatively, the fibre density of the first group 48 may be less than the fibre density of the second group 50. The distribution of the second reinforcing fibres 46 may be non-uniform. However, it is anticipated that in most embodiments, the fibre density of the second reinforcing fibres 46 is generally uniform. The second reinforcing fibres 46, with the obliquely oriented first and second groups 48, 50 on the first and second lateral sides 26, 28 increase shear resistance of the transom 10. The first and second groups 48, 50 disposed on the upper and lower sides 22 and 24 also contributes to improving the bending resistance of the transom 10. Such shear resistance is in relation to forces acting laterally on the transom 10 in opposite directions between the upper side 22 and the lower side 24. It is beneficial to have the shear resistance along the full length of the transom 10 and, therefore, the oblique arrangement of the first and second groups 48, 50, combined with the long length of the second reinforcing fibres 46 (including third group 52) wrapping about the core 20, results in a generally uniform distribution of the second reinforcing fibres 46 within the shell 40. Embodiments that require higher shear resistance in localised areas may include a non-uniform distribution of the second reinforcing fibres 46 with a high density of second reinforcing fibres 46 located at the areas which require higher shear resistance.

The transom 10 includes shear reinforcement panels 70 (FIG. 3). The shear reinforcement panels 70 are formed of fibre reinforced plastics. Each shear reinforcement panel 70 is disposed between 2 sub-core units 34. The sub-core units 34 are bonded to the shear reinforcement panels 70. The plastics (typically a curable resin) used to form these shear reinforcement panels act as an adhesive to bond sub-core units 34 to the shear reinforcement panels 70. In the embodiment shown in FIG. 3, each shear reinforcement panel extends the length of the core 20. The shear reinforcement panels 70 are aligned in a direction that is generally orthogonal to the upper and lower sides 22, 24 of the core 20. Furthermore, the panels 70 are generally parallel to the longitudinal axis 90 of the core 20.

The shear reinforcement panels 70 incorporate third reinforcing fibres 56 (as shown in FIG. 10). The third reinforcing fibres 56 includes first and second groups 56a, 56b of fibres which are parallel to the plane of the shear reinforcement panels 70 and are oblique to the longitudinal axis 90. The first and second groups 56a, 56b of third reinforcing fibres 56 may be oriented at symmetrical angles either side of the longitudinal axis 90. Alternatively, the first and second groups 56a, 56b of third reinforcing fibres 56 may be oriented at non-symmetrical angles either side of the longitudinal axis 90. The third reinforcing fibres 56 may include a third group 56c of fibres which are parallel to the plane of the shear reinforcement panels 70 and are orthogonal to the longitudinal axis 90. The first, second and third groups 56a, 56b, 56c are shown schematically in FIG. 10 as small groups of parallel fibres for clarity regarding the orientation of the fibres. However, the first, second and third groups 56a, 56b, 56c are groups of parallel fibres that are incorporated within the entire length of the shear reinforcement panel 70.

The third reinforcing fibres 56 may have ends 58 (FIG. 3) which extend beyond the shear reinforcement panels 70 at the top and bottom surface of the core 20 and into the shell 40 on the upper and lower sides 22, 24. Such extension of the third reinforcing fibres 56 contributes to force transfer from the shell 40 into the shear reinforcing panels 70 and vice versa. The result is a transom 10 with higher bending resistance and shear resistance than a transom 10 where the ends of the third reinforcing fibres 56 terminate at the edge of or within the shear reinforcement panel 70.

In an alternative embodiment, the third reinforcing fibres 56 form a fabric 60. The fabric 60 has a web width equivalent to the length of the core 20. The fabric 60 is located between adjacent sub-core units 34. However, the continuous nature of the fabric 60 results in the fabric 60 passing alternately across the upper and lower surfaces of adjacent sub-core units 34. That is, the fabric 60 is incorporated within each shear reinforcing panel 70 and extends between adjacent shear reinforcing panels 70. Those portions of the fabric 60 passing across the upper or lower surfaces of the sub-core units 34 are incorporated into the shell 40 and contribute to the force transfer described above.

The orientation of the shear reinforcement panels 70 depends upon load arrangements of the transom 10. It will be appreciated, however, that such composite load-bearing members which embody the concepts of the transom 10 can be applied to alternative load-bearing arrangements and, therefore, require different configurations of the shear reinforcement panels. In an alternative embodiment shown in FIG. 6, shear reinforcement panels 72 are aligned in a direction generally parallel to the upper and lower sides 22, 24 of the core 20. In that embodiment, the shear reinforcement panels have a plane that is parallel to the longitudinal axis 90. Sub-core units 34a have a rectangular prism shape with the distance between the upper and lower sides 36a, 38a of each sub-core unit 34a being less than the distance between the lateral sides 62a. The shell 40 remains the same as described above and the construction of the shear reinforcement panels 72 with third reinforcing fibres 56 is also the same as described above, but in a different orientation. That is, the shear reinforcement panels 72 are parallel to the upper and lower sides 22, 24 and extend between the first and second lateral sides 26, 28. The shear reinforcement panels 72 include first, second and third groups of fibres in the same orientations as the first, second and third groups 56a, 56b, 56c of third reinforcing fibres 56 described above for the shear reinforcement panels 70 and as shown in FIG. 10. More specifically, the first and second groups of fibres in the shear reinforcement panels 72 may be oriented at symmetrical angles either side of the longitudinal axis 90. Alternatively, the first and second groups of fibres in the shear reinforcement panels 72 may be oriented at non-symmetrical angles either side of the longitudinal axis 90. The third group 56c of fibres in the shear reinforcement panels 72 are parallel to the plane of the shear reinforcement panels 70 and are orthogonal to the longitudinal axis 90. Similarly, the shell 40 incorporates first, second and third groups 48, 50, 52 according to the form described above for the transom 10 shown in FIG. 3 and optionally according to the alternatives also described above.

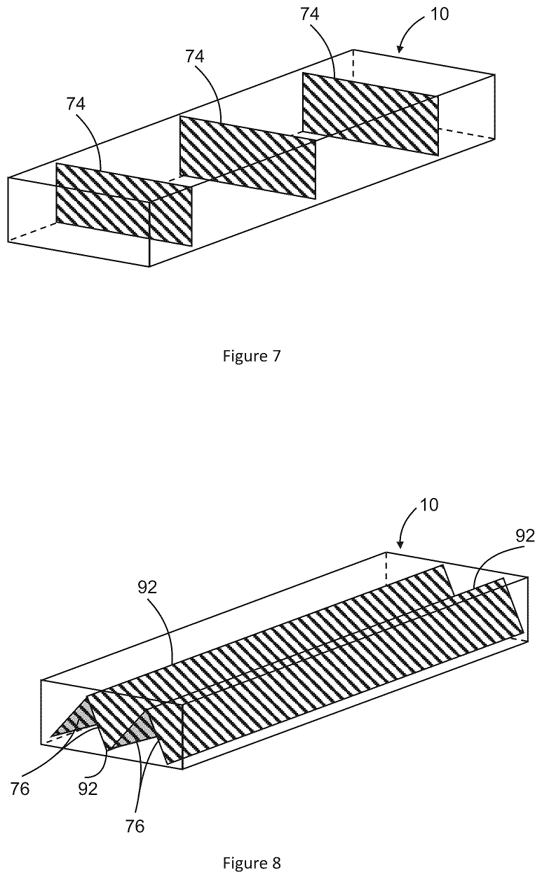

An alternative configuration of shear reinforcement panels 74 is shown in FIG. 7. In this configuration, the shear reinforcement panels 74 are disposed in parallel planes that are orthogonal to the longitudinal axis 90. Sub-core units (not shown) are disposed between adjacent shear reinforcement panels 74 and outwardly of the outermost shear reinforcement panels 74 in the direction of the longitudinal axis 90. The sub-core units have a rectangular profile the same as the profile of the core 20 of the transom 10 shown in FIG. 3. Accordingly, the shear reinforcement panel 74 are incorporated into a core has the same shape as the core 20. The composite structural member (which may be a transom, beam or panel) shown in FIG. 7 includes a shell in the same form as the shell 40 described above in respect of the transom 10 in FIGS. 1 and 3. However, it will be appreciated that the configuration of the first and second fibres in the shell may be different depending upon the load configurations applied to the composite structural member. The term “load configuration” is a reference to the 3-D orientation of mechanical stress which a structural member is subject to under normal load conditions. This includes tensile, compressive, shear and torsional forces.

A further alternative configuration of shear reinforcement panels 76 is shown in FIG. 8. In this configuration, the shear reinforcement panels 76 are aligned generally parallel to the longitudinal axis 90. However, the shear reinforcement panels 76 are also aligned obliquely to the first and second lateral sides 26, 28. While in some embodiments, the shear reinforcement panel 76 may have parallel planes, the configuration shown in FIG. 8 involves adjacent shear reinforcement panel 76 having intersecting planes. They define an M-shaped profile which extends longitudinally of the core (not shown in FIG. 8). The core for the transom 10 shown in FIG. 8 has the same rectangular profile of the core 20 shown in FIG. 3. Accordingly, the shear reinforcement panels 76 are embedded in the material forming a matrix of the core. Although the shear reinforcement panels 76 are shown in FIG. 8 as being joined along longitudinal lines of intersection 92, the shear reinforcement panels 76 may, alternatively, be spaced from each other. In other words, the shear reinforcement panels may not be joined.

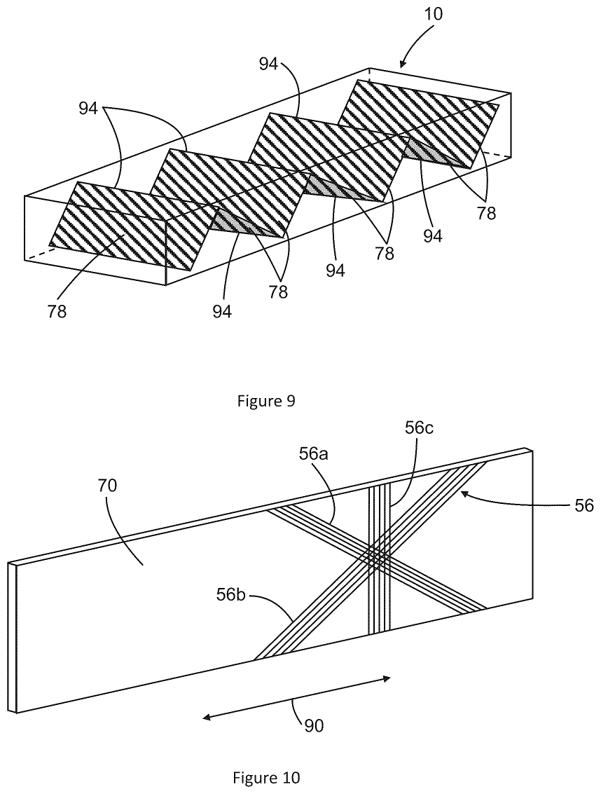

A further alternative configuration of shear reinforcement panels 78 is shown in FIG. 9. In this configuration, the shear reinforcement panels 78 are aligned obliquely to the longitudinal axis 90. However, the shear reinforcement panel 78 are also aligned obliquely to the upper and lower sides 22, 24. While in some embodiments, the shear reinforcement panels may all have parallel planes, the configuration shown in FIG. 9 involves adjacent shear reinforcement panels 78 having intersecting planes along lines of intersection 94. They define a zig-zag profile which extends laterally between the first and second lateral sides 26, 28 of the core (not shown in FIG. 9). The core for the transom 10 shown in FIG. 9 has the same rectangular profile of the core 20 shown in FIG. 3. Accordingly, the shear reinforcement panels 78 are embedded in a material forming a matrix of the core. Although the shear reinforcement panel 78 shown in FIG. 9 as being joined along transverse lines of intersection 94, the shear reinforcement panels 78 may, alternatively, be spaced from each other. In other words, the shear reinforcement panels may not be joined.

Each of the configurations shown in FIGS. 7 to 9 has the same shell 40 as described above in respect of the transom 10 shown in FIGS. 1 to 3. That is, the shell for the configurations shown in FIGS. 7 to 9 incorporates first, second and third groups 48, 50, 52 according to the shell 40 described above for the transom 10 shown in FIG. 3. Variations to the shell 40 described above in respect of the transom 10 apply equally here to the shell for the configurations shown in FIGS. 7 to 9. Furthermore, the construction of the shear reinforcement panels 74, 76, 78 with third reinforcing fibres (not shown) is also the same as described above in respect of the first, second and third groups 56a, 56b, 56c of third reinforcing fibres 56 in the shear reinforcement panels 70, as shown in FIG. 10. That is, the shear reinforcement panels 74, 76, 78 include first, second and third groups of fibres in the same orientations described above for the shear reinforcement panels 70. That is, the third group of fibres is orthogonal to the longitudinal axis 90 and the first and second groups are in the plane of the shear reinforcement panel and are oblique to the third group. The first and second groups may be symmetrically oblique either side of the third group or may be non-symmetrically oblique to the third group. The reinforcement fibres in each group are generally parallel. Furthermore, the distribution of fibres in each of the first, second and third groups may be uniform or non-uniform. In the case of non-uniform distributions, the distribution may be determined by the loading arrangements on the composite structural member, which may be a transom, beam or panel.

While FIGS. 7 to 9 show alternative arrangements of shear reinforcing panels 74, 76, 78, more complex arrangements of reinforcing panels may be adopted instead of the shear reinforcing panels 70, 72, 74, 76, 78. Such complex arrangements may include a reinforcing frame comprising numerous intersecting members, some of which may have a plane that is parallel to the longitudinal axis 90, some of which may have a plane that is orthogonal to the longitudinal axis 90 and some of which may have a plane that is oblique to the longitudinal axis 90. For example, the reinforcing frame may comprise a honeycomb structure. Some of the members forming the reinforcing frame may extend between the upper and lower sides 22, 24. Some of the members forming the reinforcing frame may extend between the first and second lateral sides 26, 28. The members may be panels, bars, rods, plates or tubes and may be straight or curved or a combination of both. The core 20 may then be assembled embedding the frame in a matrix core material, such as a flowable resin that cures or such as a combination of resin with filler material. The complex structure of a frame may preclude preparation of sub-core units in advance or it may be a simpler process to embed the frame in a flowable material rather than to form sub-core units with suitable tolerances to form the core 20. The filler material may be organic material or synthetic material. An example of organic filler material is wood chips and an example of a synthetic material is an adhesive or resin.

One method of constructing the transom 10 involves wrapping the core 20 in the first and second reinforcing fibres 44, 46. This involves wrapping those fibres 44 and 46 separately of one another, optionally in alternating layers. An alternative method involves combining the first and second reinforcing fibres in a fabric 80 and wrapping the fabric about the core 20, as shown in FIG. 4. The fabric 80 shown includes first and second lateral edges 82, 84 and a leading edge 86. The embodiment shown in FIG. 4 shows the first and second edges 82, 84 extending beyond the length of the core. The method, therefore, involves folding the parts of the fabric which extend beyond the first and second court end 30, 32 onto the core ends 30, 32 so as to envelop the core 20 within the fabric 80 on all sides. In this form, the first reinforcing fibres extend from the first core end 30, across the upper or lower side 22, 24 and terminate at the second core end 32. However, in an alternative embodiment the fabric 80 has a width that is less than or equal to the distance between the first and second core ends 30, 32, so that the first reinforcing fibres 44 extend across the upper and lower sides 22, 24 and the first and second lateral sides 26, 28, but not the first or second core ends 30, 32.

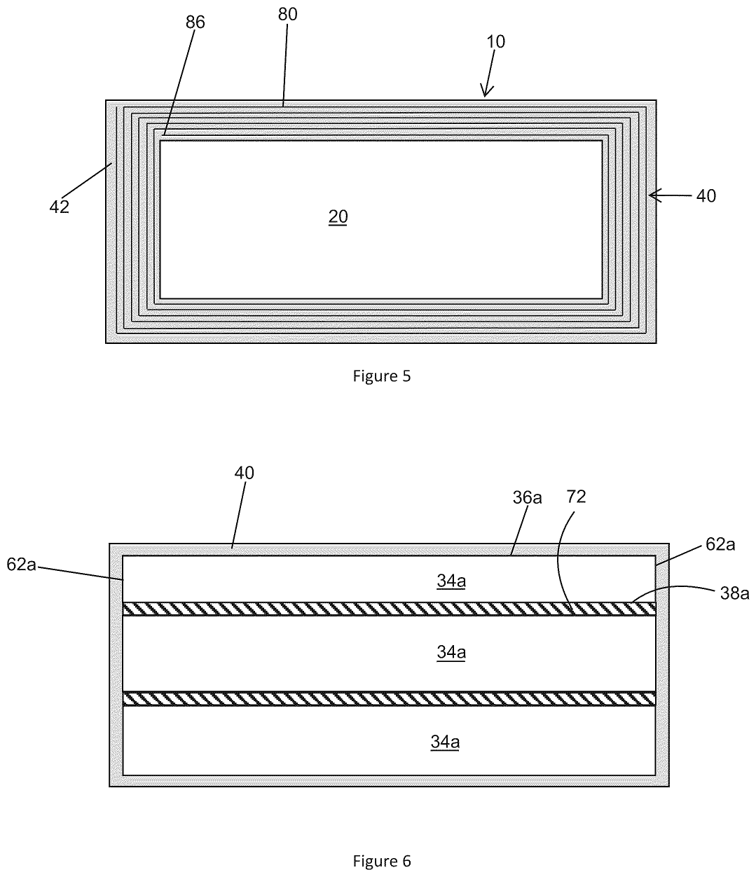

The leading edge 86 is fixed to the core 20 and then the core is rotated about the longitudinal axis 90 in the direction of rotation indicated by the arrow “R” in FIG. 4. Such rotation causes wrapping of the fabric around the core 20 circumferentially relative to longitudinal axis 90. The effect is a spiral winding of fabric about core 20 as shown in FIG. 5. An alternative to this method involves fixing the leading edge 86 to the core 20 and then wrapping the fabric 80 circumferentially around the core 20 while the core 20 is stationary.

The fabric 80 may be formed by weaving the first reinforcing fibres 44 with the first, second and third groups 48, 50, 52 of second reinforcing fibres 46. Alternatively, the fabric may be formed by sewing together sub-layers of the first reinforcing fibres 44 with the first, second and third groups 48, 50, 52 of second reinforcing fibres 46. Either way, the fabric 80 incorporates the first reinforcing fibres 44 with the first, second and third groups 48, 50, 52 of second reinforcing fibres 46 in a single layer so when the fabric 80 is wrapped around the core 20, each layer of wrapping includes a sub-layer of first reinforcing fibres 44 and a sub-layer of each of first, second and third groups 48, 50, 52 of second reinforcing fibres 46. This enables the sub-layers of first reinforcing fibres 44 to be interleaved between sub-layers of layers the second reinforcing fibres 46. This reduces the risk of delaminating the shell 40 by having all of the first reinforcing fibres 44 in a layer that is separate from all of the second reinforcing fibres 46. The method of preparing the fabric 80 with the first and second reinforcing fibres is known and relies on knowing the distribution and orientation of the first and second reinforcing fibres 44, 46. Those details can be determined by a skilled person based on the loading arrangements to which the transom 10 or other composite structural member incorporating the concepts of the transom 10 will be subjected.

The number of layers of winding a fabric around the core 20 depends upon the load-bearing requirements of the transom 10. That is, more windings of the fabric 80 around the core 20 results in more layers of first and second reinforcing fibres, therefore providing more resistance to bending for the formed transom 10.

Winding of the fabric 80 around the core 20 partially forms the shell 40. The shell 40 is formed by combining the fabric with a plastics material. Typically, the plastics material is one that cures over a period time or upon exposure to certain conditions, such as heat. Any suitable plastics material may be used. In this particular embodiment, the plastics material comprises a resin that is applied in a liquid form and that cures over time. Furthermore, in this embodiment, the resin is applied to the fabric 80 shortly before the fabric 80 is wound onto the core 20. Accordingly, the fabric 80 is wetted with the resin and then wound onto the core 20 where the resin cures to form the shell 40.

Alternatively, the resin may be applied to the fabric 80 once it has already been wound onto the core 20, but while wrapping of further fabric 80 is ongoing. In another alternative, the resin may be applied to the fabric 80 after wrapping of the core with the fabric 80 has been completed. In this alternative, the resin may be applied by resin infusion processes or by resin transfer processes.

In the event that the core 20 is not monolithic, such as with the transom 10 shown in FIG. 3, the core 20 is assembled from the sub core units 34 and either the third reinforcing fibres 56 or pre-formed shear reinforcement panels 70. In the case of pre-formed shear reinforcement panels 70, the sub core units 34 and the shear reinforcement panels 70 are assembled to form the core 20 by adhering the sub core units 34 to the shear reinforcement panels 70 with the same resin used to form the shear reinforcement panels 70. In the case of the sub core units 34 being assembled with the third reinforcing fibres 56, the sub core units 34 are brought together with a mat of the third reinforcing fibres having the shape of the shear reinforcing panels 70 disposed between adjacent sub-core units 34 or with the fabric 60 disposed between adjacent sub-core units 34. The resin used to form the shear reinforcing panels 70 is applied to the mat or the fabric 60 prior to being brought together with adjacent sub-core units 34. In this way, the resin acts as an adhesive to bond the adjacent sub-core units to the shear reinforcement panels 70. However, an alternative approach involves disposing the mat or the fabric 60 between adjacent sub-core units 34 to partially assemble the core 20 without the resin which forms the shear reinforcing panels 70. The partially formed core 20 is then wrapped with the fabric 80 as described above, during which or after which the application of the resin 42 which forms part of the shell 40 is applied in a way that flows into the space between adjacent sub-core units and embeds the mat or fabric 60 in the same resin 42 that forms part of the shell 40. In this approach, the resin 42 which forms part the shell 40 also forms part of the shear reinforcing panels 70 so that the shear reinforcing panels 70 are integrally formed with the shell 40. This reduces the chances of mechanical disconnection between the shear reinforcing panels 70 and the shell 40.

Furthermore, the composite structural member (examples include the transom 10 described here, along with the described variations, and include a beam and a panel) has been described in connection with what are presently considered to be the most practical and preferred embodiments, it is to be understood that the composite structural member and the method for forming the composite structural member is not to be limited to the disclosed embodiments, but on the contrary, is intended to cover various modifications and equivalent arrangements included within the spirit and scope of the concepts embodied in the composite structural member and the method for forming the composite structural member. Also, the various embodiments described above may be implemented in conjunction with other embodiments, for example, aspects of one embodiment may be combined with aspects of another embodiment to realize yet other embodiments. Further, each independent feature or component of any given assembly may constitute an additional embodiment.

For example, while the above description relates to a transom 10, the same construction principles can be adopted to form alternative composite structural members, such as beams and panels (e.g. decking, such as railway bridge decking). The transom 10 has a profile where the distance between the upper and lower sides 22, 24 is greater than the distance between the first and second lateral sides 26, 28. Accordingly, the width dimension of the transom 10 is greater than the height dimension. For a beam, however, the width dimension may be less than the height dimension, but the same core 20/shell structure is still part of the beam and it is still formed using the same method described above. By way of example of alternative composite structural members, the same core 20/shell 40 construction principles described above in respect of the transom 10 can be applied to railway sleepers, railway turnout bearers and bridge beams. Bridge beams, for example, which incorporate the construction principles described above may support transoms. The term “composite structural member” isn't limited to those examples and may include other structural members which can be formed with the same construction principles described above. However, the load configuration in each alternative composite structural member may differ from the transom 10, so the shape of the core 20, the orientation of the first, second and third groups of second reinforcing fibres 46 and the fibre densities of the first, second and third reinforcing fibres 44, 46, 56 are selected to account for the different load configuration. Other variable factors described above may also be varied to account for the different load configuration, including whether to include reinforcement panels or a composite reinforcement frame and including the configuration of the reinforcement panels or the reinforcement frame.

In the foregoing description of preferred embodiments, specific terminology has been resorted to for the sake of clarity. However, the invention is not intended to be limited to the specific terms so selected, and it is to be understood that each specific term includes all technical equivalents which operate in a similar manner to accomplish a similar technical purpose. Terms such as “front” and “rear”, “top” and “underneath”, “above”, “below”, “upper” and “lower” and the like are used as words of convenience to provide reference points and are not to be construed as limiting terms.

The term “fabric”, as used in the description and the claims, is a reference to an arrangement of first and second reinforcing fibres in a sheet or web form. The fibres may be woven, sewn, welded or adhered together to form the fabric. The term “fabric” should not be construed as implying any dimensions to the fabric.

For example, the transom 10 shown in FIG. 3 has two-fold rotational symmetry about the longitudinal axis which means that the transom 10 may have the upper side 22 facing downwardly toward the ground in use because the orientation of the reinforcing fibres is the same in the shell 40 on the upper and lower sides 22, 24 and in the reinforcement panels 70. This means that the transom 10 will have the same mechanical performance in use when the upper side 22 is facing upwardly away from the ground and when it is facing downward toward the ground. This may not be the case where the transom 10 is formed without rotational symmetry and, in such circumstances, the transom 10 will have a directional orientation for use where the upper side 22 must face upwardly away from the ground in use.

In the claims which follow, and in the preceding description, except where the context requires otherwise due to express language or necessary implication, the word “comprise” and variations such as “comprises” or “comprising” are used in an inclusive sense, i.e. to specify the presence of the stated features but not to preclude the presence or addition of further features in various embodiments of the apparatus and method as disclosed herein.

1. A composite load-bearing member including:
a core with opposed upper and lower side and opposed lateral sides extending between the upper and lower side and opposed ends extending between the upper and lower sides and between the lateral sides and with a longitudinal axis extending through the ends, the core being substantially solid; and
a shell that is bonded to the core on at least the upper, lower and lateral sides and that includes first reinforcing fibres and second reinforcing fibres in a first resin matrix; and
wherein the first reinforcing fibres are parallel to the longitudinal axis and the second reinforcing fibres are oblique to the longitudinal axis.

2. The composite load-bearing member defined in claim 1, wherein the first reinforcing fibres wrap continuously from one of the ends and across the upper side or the lower side to the other end.

3. The composite load-bearing member defined in claim 1, wherein at least some of the second reinforcing fibres wrap continuously and helically from the upper or lower sides and across the lateral side to the lower or upper side, respectively.

4. The composite load-bearing member defined in claim 3, wherein the second reinforcing fibres include a first group that is oriented at one or more first oblique angles (A) to the longitudinal axis and a second group that is oriented at one or more second oblique angles (B) to the longitudinal axis.

5. The composite load-bearing member defined in claim 4, wherein the angle A is in the range of +>0° to <90° to the longitudinal axis and the angle B is in the range of −>0° to <90° to the longitudinal axis.

6. The composite load-bearing member defined in claim 1, wherein the fibre density of the first reinforcing fibres and/or the second reinforcing fibres is in the range of 100 to 30,000 g/m².

7. The composite load-bearing member defined claim 1, wherein the core includes a plurality of sub-core units and adjacent sub-core units that are bonded to a shear reinforcement panel.

8. The composite load-bearing member defined in claim 7, wherein the or each shear reinforcement panel extends between the upper and lower sides of the core and is aligned in a direction generally orthogonal to the upper and lower sides of the core.

9. The composite load-bearing member defined in claim 7, wherein the or each shear reinforcement panel includes third reinforcing fibres in a resin matrix.

10. The composite load-bearing member defined in claim 9, wherein the fibre density of the third reinforcing fibres is in the range of 100 to 10,000 g/m².

11. The composite load-bearing member defined in claim 9, wherein at least part of the third reinforcing fibres extends across the upper or lower side of one of the sub-core units and across the lower or upper side, respectively, of an adjacent one of the sub-core units.

12. The composite load-bearing member defined in claim 9, wherein at least part of the third reinforcing fibres are incorporated into the shell.

13. A method of producing a composite load-bearing member comprising a core with opposed upper and lower side and opposed lateral sides extending between the upper and lower side and opposed ends extending between the upper and lower sides and between the lateral sides and with a longitudinal axis extending through the ends, the core being substantially solid; and including a shell that is bonded to at least the upper, lower and lateral sides of the core and that includes first reinforcing fibres and second reinforcing fibres in a first resin matrix, the first reinforcing fibres are parallel to the longitudinal axis and the second reinforcing fibres are oblique to the longitudinal axis;
the method including:
providing the core;
wrapping the first reinforcing fibres and the second reinforcing fibres around the core so that the first reinforcing fibres are parallel to the longitudinal axis and the second reinforcing fibres are oblique to the longitudinal axis; and
forming and bonding the shell to the core by applying the first resin to the first reinforcing fibres and the second reinforcing fibres and allowing the resin to cure.

14. The method defined in claim 13, wherein the method includes providing the first and the second reinforcing fibres as a fabric that has a width which is less than, equal to or greater than the distance between the ends of the core and whereby wrapping the first reinforcing fibres and the second reinforcing fibres around the core involves wrapping the fabric around the core.

15. The method defined in claim 14, wherein wrapping the fabric around the core includes connecting a leading edge of the fabric to the core and then rotating the core about the longitudinal axis to wrap the fabric circumferentially around the core.

16. The method defined in claim 14, wherein wrapping the fabric around the core includes connecting a leading edge of the fabric to the core and then wrapping the fabric circumferentially around the core while the core is stationary.

17. The method defined in claim 15, wherein connecting the leading edge of the fabric to the core includes fixing the leading edge between adjacent sub-core units by clamping the leading edge between the sub-core units or by adhering the leading edge to one of the sub-core units in a space between adjacent sub-core units or by fastening the leading edge with mechanical fasteners to one of the sub-core units in a space between adjacent sub-core units.

18. The method defined in claim 13, wherein wrapping the first reinforcing fibres and the second reinforcing fibres around the core includes wrapping at least some of the second reinforcing fibres continuously and helically from the upper or lower sides and across at least one of the lateral sides to the lower or upper side, respectively.

19. The method defined in claim 13, wherein the core includes a plurality of sub-core units and the method includes arranging third reinforcing fibres between the sub-core units prior to wrapping the first and second reinforcing fibres around the core.

20. The method defined in claim 19, wherein arranging the third reinforcing fibres includes arranging a web of the third reinforcing fibres between adjacent sub-core units and alternately across upper sides and lower sides of adjacent sub-core units.
